(19) United States
(12) Patent Application Publication
(10) Pub. No.: US 2026/0175410 A1
(43) Pub. Date: Jun. 25, 2026

(54) VERTICAL ARTICULATED ROBOT

(71) Applicant: SEIKO EPSON CORPORATION, Tokyo (JP)

(72) Inventor: Daichi TAKAHARA, MATSUMOTO-SHI (JP)

(21) Appl. No.: 19/431,961

(22) Filed: Dec. 23, 2025

(30) Foreign Application Priority Data
Dec. 25, 2024 (JP) 2024-228422

(51) Int. Cl. B25J 9/10; B25J 18/00

(52) U.S. Cl. CPC B25J 9/108; B25J 9/102; B25J 18/00

(57) ABSTRACT

A fifth arm includes a first bearing that is disposed in a first opening portion, has an outer ring and an inner ring, and rotatably supports a first shaft portion, a pressing portion that includes a holding portion fixed to a first protrusion portion and an elastic member disposed between the holding portion and the first bearing, the pressing portion pressing the outer ring from an outside along a rotation axis, in which an operation portion protrudes outward beyond the first protrusion portion and the pressing portion.

### CROSS-REFERENCE TO RELATED APPLICATIONS

The present application is based on, and claims priority from JP Application Serial Number 2024-228422, filed December 25, 2024, the disclosure of which is hereby incorporated by reference herein in its entirety.

### BACKGROUND OF THE INVENTION

### 1. Technical Field

The present disclosure relates to a vertical articulated robot.

### 2. Related Art

JP-A-2022-070647 discloses a configuration of a robot in which an input bevel gear is rotatably supported via a bearing, and the bearing is retained by a bearing retainer, thereby restricting movement of the bearing in an axial direction.

However, in the configuration described in JP-A-2022-070647, there is a problem that the bearing cannot be firmly fixed or the bearing is excessively pressed due to the deformation of the bearing retainer caused by thermal expansion or the like, so that backlash of the input bevel gear does not fall within an appropriate range and the gear contact accuracy deteriorates.

### SUMMARY OF THE INVENTION

According to an aspect of the present disclosure, a vertical articulated robot includes a root arm member that includes a motor, a first arm member that is provided at the root arm member and is rotated around a first axis, and a second arm member that is provided at the first arm member and is rotated around a second axis intersecting with the first axis, in which the first arm member includes a housing that includes a first protrusion portion protruding along the first axis and a first opening portion provided on an inside of the first protrusion portion, a first bevel gear that includes a first shaft portion extending along the first axis, an operation portion provided at one end of the first shaft portion and having a step or a recessed portion, and a first bevel gear portion provided at another end of the first shaft portion, the first bevel gear being inserted into the first opening portion, a first bearing that is disposed in the first opening portion, includes an outer ring and an inner ring, and rotatably supports the first shaft portion, and a pressing portion that includes a holding portion fixed to the first protrusion portion and an elastic member disposed between the holding portion and the first bearing, the pressing portion pressing the outer ring from an outside along the first axis, and the operation portion protrudes outward beyond the first protrusion portion and the pressing portion.

### BRIEF DESCRIPTION OF DRAWINGS

FIG. 1 is a schematic diagram illustrating a configuration of a vertical articulated robot.

FIG. 2 is a cross-sectional view illustrating a configuration of a distal end of the vertical articulated robot.

FIG. 3 is an enlarged cross-sectional view illustrating a portion III of the vertical articulated robot illustrated in FIG. 2.

FIG. 4 is an enlarged perspective view illustrating a portion IV of the vertical articulated robot illustrated in FIG. 3.

FIG. 5 is an enlarged perspective view illustrating the portion V of the vertical articulated robot illustrated in FIG. 3.

FIG. 6 is an enlarged cross-sectional view illustrating the portion VI of the vertical articulated robot illustrated in FIG. 3.

FIG. 7A is a perspective view illustrating a configuration of a holding portion that constitutes a pressing portion.

FIG. 7B is a perspective view illustrating a configuration of an elastic member that constitutes the pressing portion.

FIG. 7C is a perspective view illustrating a configuration of a spacer that constitutes the pressing portion.

FIG. 8 is a plan view illustrating a configuration of the pressing portion.

FIG. 9 is a cross-sectional view for describing a method of adjusting backlash.

FIG. 10A is a perspective view illustrating a configuration of an elastic member of a modification example.

FIG. 10B is a perspective view illustrating the configuration of the elastic member of the modification example.

FIG. 10C is a perspective view illustrating the configuration of the elastic member of the modification example.

FIG. 11A is a perspective view illustrating a configuration of a spacer of the modification example.

FIG. 11B is a perspective view illustrating the configuration of the spacer of the modification example.

FIG. 12A is a plan view illustrating a configuration of a holding portion of the modification example.

FIG. 12B is a cross-sectional view taken along the line XIIB-XIIB of the holding portion illustrated in FIG. 12A.

FIG. 13 is a cross-sectional view illustrating a configuration of a vertical articulated robot of the modification example.

### DETAILED DESCRIPTION OF THE INVENTION

Hereinafter, a configuration of a vertical articulated robot 1 will be described with reference to the drawings. In the following drawings, three axes orthogonal to each other will be described as an X axis, a Y axis, and a Z axis. A direction along the X axis is referred to as an "X direction", a direction along the Y axis is referred to as a "Y direction", and a direction along the Z axis is referred to as a "Z direction". A direction of an arrow is referred to as a + direction, and a direction opposite to the + direction is referred to as a - direction. In addition, viewing from a +Z direction or a -Z direction is also referred to as a plan view or a planar view.

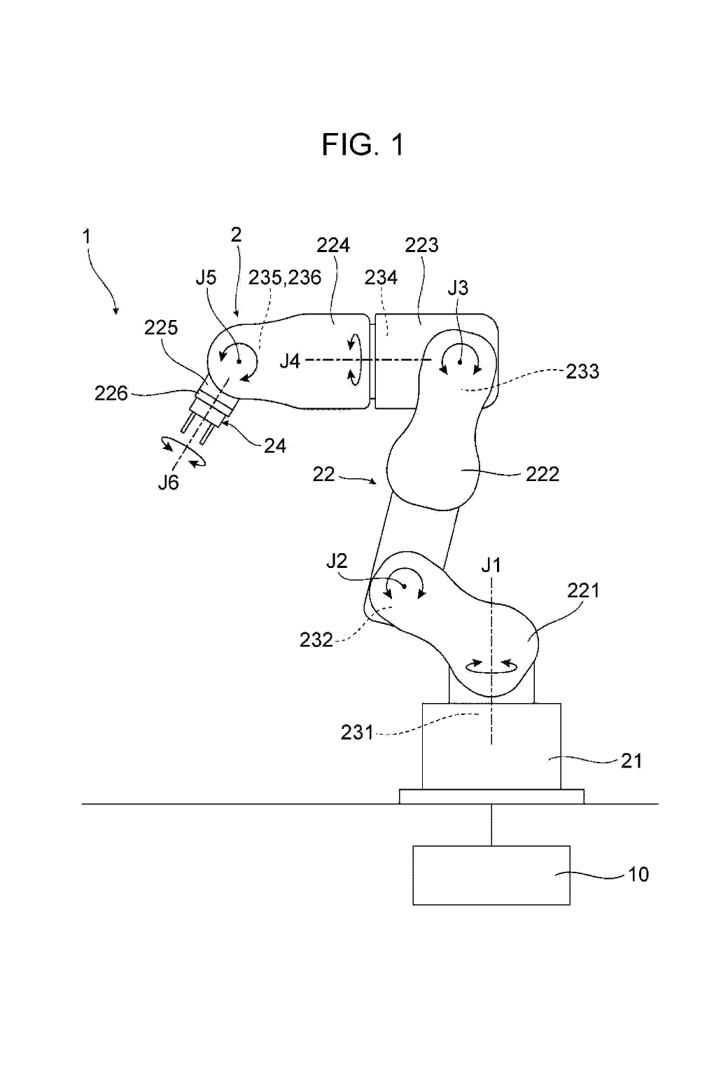

First, the configuration of the vertical articulated robot 1 will be described with reference to FIG. 1.

As illustrated in FIG. 1, the vertical articulated robot 1 includes a robot main body 2 and a controller 10 that controls driving of the robot main body 2.

The vertical articulated robot 1 is, for example, a 6-axis robot having six drive axes. The vertical articulated robot 1 includes a base 21 fixed to a floor and a robot arm 22 coupled to the base 21.

The robot arm 22 includes a first arm 221, a second arm 222, a third arm 223, a fourth arm 224 as a root arm member, a fifth arm 225 as a first arm member, and a sixth arm 226 as a second arm member.

The first arm 221 is coupled to the base 21 and is rotated around a rotation axis J1 with respect to the base 21. The second arm 222 is coupled to the first arm 221 and is rotated around a rotation axis J2 with respect to the first arm 221. The third arm 223 is coupled to the second arm 222 and is rotated around a rotation axis J3 with respect to the second arm 222. The fourth arm 224 is coupled to the third arm 223 and is rotated around a rotation axis J4 with respect to the third arm 223. The fifth arm 225 is coupled to the fourth arm 224 and is rotated around a rotation axis J5 as a first axis with respect to the fourth arm 224. The sixth arm 226 is coupled to the fifth arm 225 and is rotated around a rotation axis J6 as a second axis with respect to the fifth arm 225. An end effector 24 is coupled to the distal end of the sixth arm 226. In addition, the base 21 and the first arm 221, and each of the arms are coupled to each other via a joint. Each rotation axis is a virtual straight line.

The robot main body 2 includes a first driving mechanism 231, a second driving mechanism 232, a third driving mechanism 233, a fourth driving mechanism 234, a fifth driving mechanism 235, and a sixth driving mechanism 236.

The first driving mechanism 231 rotates the first arm 221 around the rotation axis J1 with respect to the base 21. The second driving mechanism 232 rotates the second arm 222 around the rotation axis J2 with respect to the first arm 221. The third driving mechanism 233 rotates the third arm 223 around the rotation axis J3 with respect to the second arm 222. The fourth driving mechanism 234 rotates the fourth arm 224 around the rotation axis J4 with respect to the third arm 223. The fifth driving mechanism 235 rotates the fifth arm 225 around the rotation axis J5 with respect to the fourth arm 224. The sixth driving mechanism 236 rotates the sixth arm 226 around the rotation axis J6 with respect to the fifth arm 225.

The controller 10 independently controls the driving mechanisms 231 to 236 to cause the robot main body 2 to perform a predetermined work. The controller 10 is configured with, for example, a computer, and includes a processor that processes information, a memory that is communicably connected to the processor, and an external interface. Various programs executable by the processor are stored in the memory. The processor can read and execute various programs and the like stored in the memory.

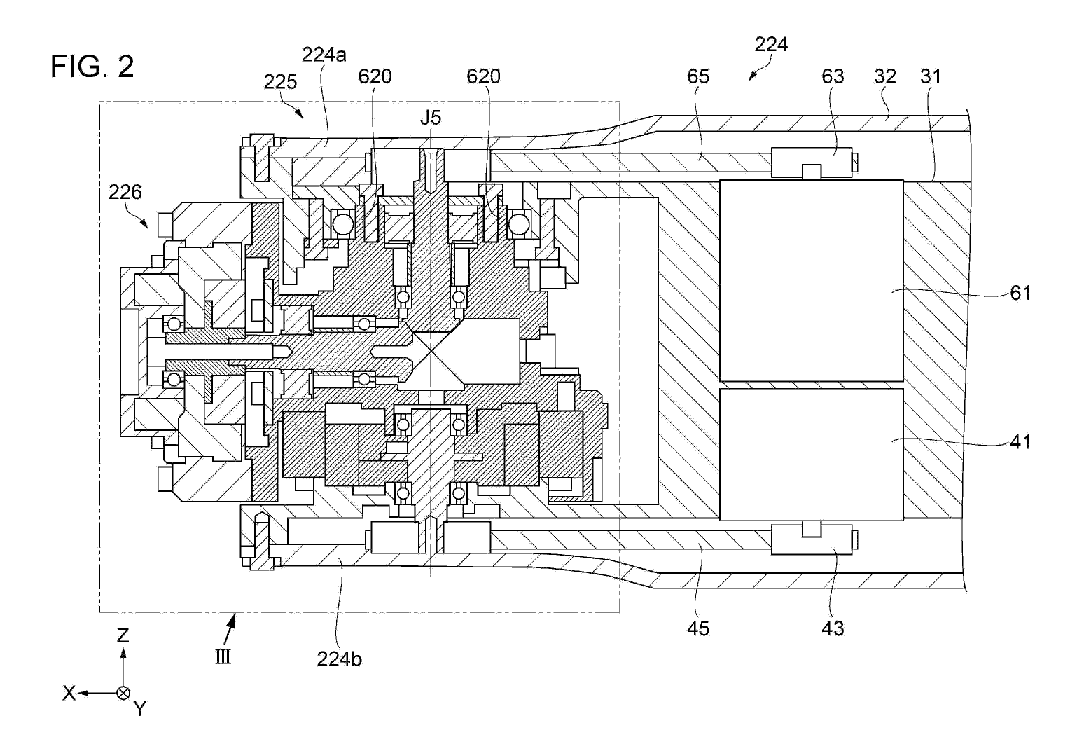

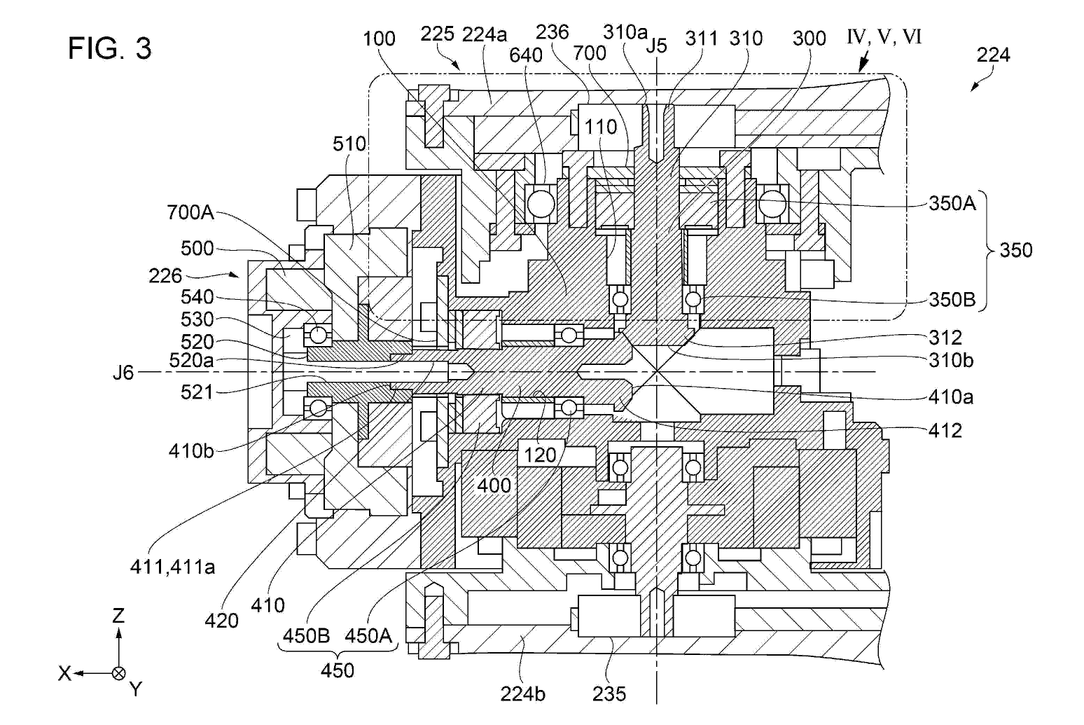

Next, a configuration of a distal end arm, specifically, the fourth arm 224 to the sixth arm 226 will be described with reference to FIGS. 2 and 3.

As illustrated in FIGS. 2 and 3, the distal end portion of the fourth arm 224 is divided into two portions, and the fifth arm 225 is double-supported therebetween at both sides of the rotation axis J5. The sixth driving mechanism 236 is disposed at an upper distal end portion 224a, and the fifth driving mechanism 235 is disposed at a lower distal end portion 224b. As described above, by double-supporting the fifth arm 225, the rotation accuracy of the fifth arm 225 is improved, and the disposition space of the fifth driving mechanism 235 and the sixth driving mechanism 236 can be separately secured.

The fourth arm 224 includes a case 31 and a cover 32 attached to the case 31. The proximal end portion of the case 31 is rotatably coupled to the third arm 223. The distal end portion of the case 31 is rotatably coupled to the fifth arm 225.

An encoder-integrated motor 41, a pulley 43 attached to an output shaft of the motor 41, and a power transmission belt 45 wound around the pulley 43 are fixed to the case 31. In addition, an encoder-integrated motor 61, a pulley 63 attached to an output shaft of the motor 61, and a power transmission belt 65 wound around the pulley 63 are fixed to the case 31.

As illustrated in FIG. 3, the fifth arm 225 includes a housing 100, a first bevel gear 300, a first bearing 350, a second bearing 640, a second bevel gear 400, and a third bearing 450.

The housing 100 includes a first opening portion 110 and a second opening portion 120 provided at a position different from the first opening portion 110. The first opening portion 110 and the second opening portion 120 are connected to each other internally.

The first bevel gear 300 is inserted into the first opening portion 110. The first bevel gear 300 includes a first shaft portion 310 extending along the rotation axis J5 as a first axis, an operation portion 311 including a step or a recessed portion provided at one end 310a of the first shaft portion 310, and a first bevel gear portion 312 provided at another end 310b of the first shaft portion 310.

The first shaft portion 310 has a stepped shape in which the diameter increases from the operation portion 311 toward the first bevel gear portion 312. The first bearing 350 includes a plurality of first bearings 350A and 350B disposed to correspond to the stepped shape.

The first bearing 350 rotatably supports the first shaft portion 310 with respect to the housing 100. The first bearing 350 includes the first bearing 350A disposed on the side of the one end 310a of the first shaft portion 310 and the first bearing 350B disposed on the side of another end 310b of the first shaft portion 310.

The second bevel gear 400 is inserted into the second opening portion 120. The second bevel gear 400 includes a second shaft portion 410 extending along the rotation axis J6 as a second axis, a second bevel gear portion 412 provided at one end 410a of the second shaft portion 410 and receiving a force by meshing with the first bevel gear portion 312, and a coupling portion 411 provided at another end 410b of the second shaft portion 410.

The second shaft portion 410 has a stepped shape in which the diameter increases from the coupling portion 411 toward the second bevel gear portion 412. The third bearing 450 includes a plurality of third bearings 450A and 450B disposed to correspond to the stepped shape.

The third bearing 450 rotatably supports the second shaft portion 410 with respect to the housing 100. The third bearing 450 includes the third bearing 450A disposed on the side of the one end 410a of the second shaft portion 410 and the third bearing 450B disposed on the side of another end 410b of the second shaft portion 410.

As described above, since the first shaft portion 310 and the second shaft portion 410 have a stepped shape in which the diameter increases toward the center portion of the housing 100, the plurality of bearings 350A, 350B, 450A, and 450B can be inserted in order, and the assembly work of the fifth arm 225 can be easily performed.

The sixth arm 226 includes a flange 500, a speed reducer 510 that is coupled to the flange 500 and amplifies the received force to drive the flange 500, and a fitting member 520 that is inserted into the speed reducer 510 and is detachably fitted to the coupling portion 411 of the second shaft portion 410.

A recessed portion 520a is provided in a part of the fitting member 520, specifically, on the side of the coupling portion 411 of the second bevel gear 400. A part of the coupling portion 411 of the second bevel gear 400 is provided with a projection portion 411a. The second bevel gear 400 and the fitting member 520 are disposed such that the recessed portion 520a and the projection portion 411a are fitted to each other.

As described above, since the recessed portion 520a and the projection portion 411a are fitted to each other, the position of the second bevel gear 400 and the fitting member 520, in other words, the fifth arm 225 and the speed reducer 510 can be determined. Specifically, since the second bevel gear 400 is supported by the two third bearings 450A and 450B, even in a case where the speed reducer 510 is attached to the second bevel gear 400, the bending of the second bevel gear 400 can be suppressed. In addition, since the length of the fitting member 520 having a large outer diameter can be shortened, the cost of the material can be reduced.

The fitting member 520 is provided with a through-hole 521. A female screw portion 420 is provided at the end portion of the second bevel gear 400 on the coupling portion 411 side. The recessed portion 520a and the projection portion 411a are fitted to each other to support the fitting member 520, and the fitting member 520 is fixed to the female screw portion 420 of the second bevel gear 400 by a fixing screw 530 passing through the through-hole 521.

As described above, the fitting member 520 and the second bevel gear 400 are fixed, and thus the fifth arm 225 in which the second bevel gear 400 is disposed and the speed reducer 510 into which the fitting member 520 is inserted can be easily attached and detached.

The speed reducer 510 is, for example, a wave speed reducer including a wave generator. A fifth bearing 540 is disposed on the outer periphery of the fitting member 520 on the sixth arm 226 side. As described above, the fifth arm 225 side of the speed reducer 510 into which the fitting member 520 is inserted is supported by fitting the recessed portion 520a of the fitting member 520 and the projection portion 411a of the second bevel gear 400. On the other hand, the sixth arm 226 side of the speed reducer 510 into which the fitting member 520 is inserted is supported by the fifth bearing 540. In other words, since the wave generator of the speed reducer 510 has a double-support structure, eccentricity of the speed reducer 510 or the occurrence of abnormal wear on the gear surface due to the eccentricity can be suppressed.

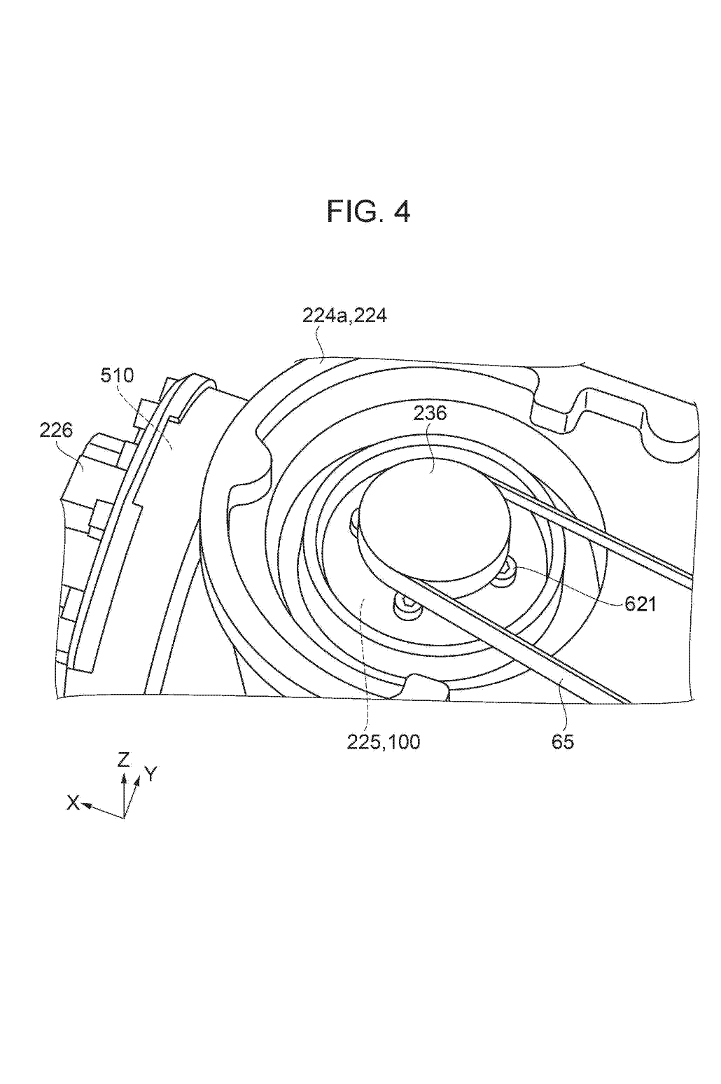

Next, a configuration of a coupling portion between the fourth arm 224 and the fifth arm 225 will be specifically described with reference to FIGS. 4 to 6.

As illustrated in FIG. 4, the vertical articulated robot 1 includes the fourth arm 224, the fifth arm 225, and the sixth arm 226.

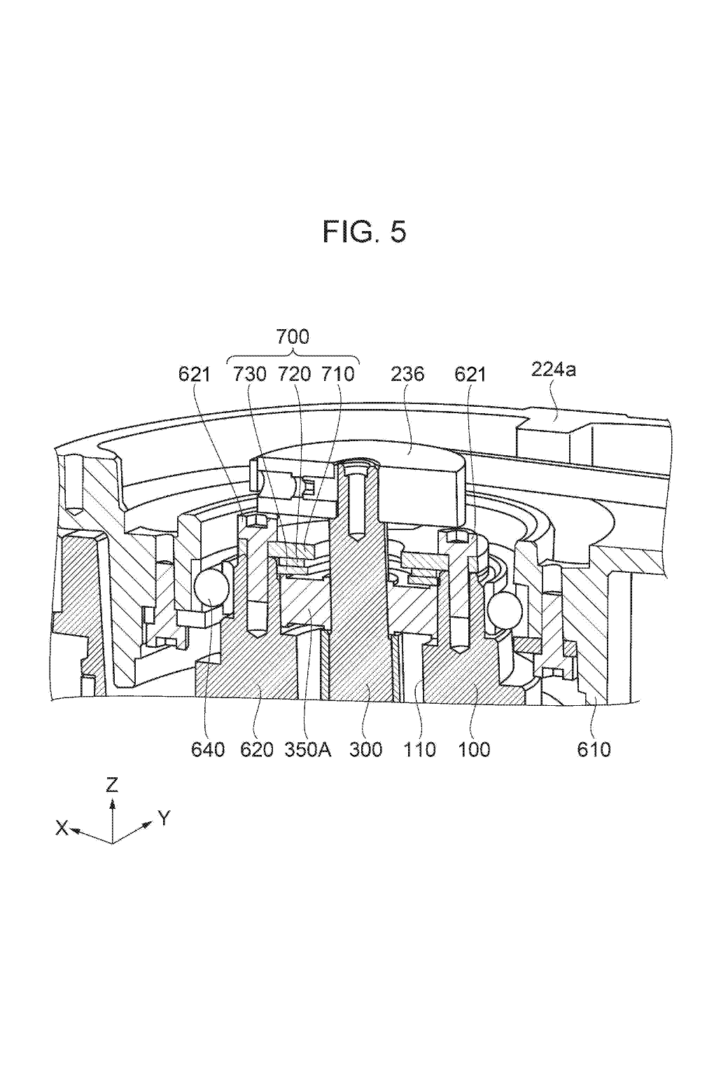

As described above, the fourth arm 224 includes the motor 61 (refer to FIG. 2), the pulley 63 (refer to FIG. 2) attached to the output shaft of the motor 61, and the power transmission belt 65 wound around the pulley 63. As illustrated in FIG. 5, the fourth arm 224 includes a tubular second protrusion portion 610 protruding in the -Z direction along the rotation axis J5.

The fifth arm 225 includes a substantially cylindrical-shaped first protrusion portion 620 protruding in the +Z direction along the rotation axis J5. The first protrusion portion 620 is a part of the housing 100. The first opening portion 110 into which the first bevel gear 300 constituting a power transmission mechanism is inserted is provided on the inside of the first protrusion portion 620. The second bearing 640 is supported on the outside of the first protrusion portion 620. The first bearing 350A is supported on the inside of the first protrusion portion 620.

A pressing portion 700 that supports the first bearing 350A is disposed at the distal end of the first protrusion portion 620, that is, at the end portion on the +Z direction side. The first bearing 350A includes an outer ring 350A1 and an inner ring 350A2. The pressing portion 700 is pressed in the direction of the rotation axis J5, specifically, in the -Z direction by a holding portion 710, and is fixed to the first protrusion portion 620.

The pressing portion 700 includes the holding portion 710 fixed to the first protrusion portion 620, a spacer 730 disposed on the first bearing 350A side, and the elastic member 720 disposed between the holding portion 710 and the spacer 730. The pressing portion 700 presses the outer ring 350A1 of the first bearing 350A from the outside along the rotation axis J5.

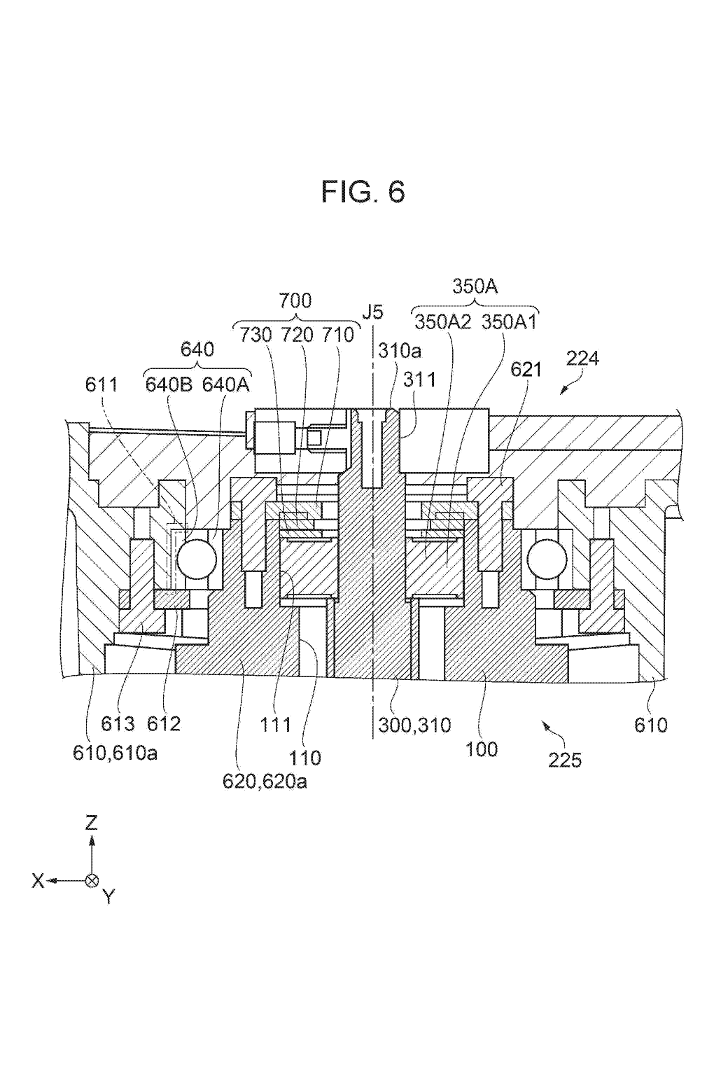

As illustrated in FIG. 6, the fourth arm 224 includes the tubular second protrusion portion 610 protruding in the -Z direction along the rotation axis J5. The second protrusion portion 610 includes a step portion 610a on the inside. Specifically, the second protrusion portion 610 is provided such that the thickness increases in the +Z direction.

The second protrusion portion 610 includes a shoulder portion 611 in a part of the step portion 610a. The shoulder portion 611 includes a wall portion extending along a virtual straight line parallel to the rotation axis J5 and a bottom portion extending along a virtual first straight line intersecting with the rotation axis J5, particularly orthogonal to the rotation axis J5. The second bearing 640 is disposed on the inside of the shoulder portion 611. The second bearing 640 is an annular member that rotatably supports the fifth arm 225 with respect to the fourth arm 224, and includes an inner ring 640A and an outer ring 640B disposed on the outside of the inner ring 640A.

In the second bearing 640, the outer ring 640B is pinched and fixed by the bottom portion of the shoulder portion 611 of the second protrusion portion 610 and an outer ring pinching portion 612. The outer ring pinching portion 612 extends along a virtual second straight line intersecting with the rotation axis J5, particularly orthogonal to the rotation axis J5, is pressed in the direction of the rotation axis J5, specifically, in the +Z direction by a fixing bolt 613, and is fixed to the second protrusion portion 610. The first straight line and the second straight line are parallel, that is, the bottom portion of the shoulder portion 611 and the outer ring pinching portion 612 are parallel, but the first straight line and the second straight line may not be parallel.

The fifth arm 225 includes a substantially cylindrical-shaped first protrusion portion 620 protruding in the +Z direction along the rotation axis J5. The first protrusion portion 620 is a part of the housing 100 described above. The first protrusion portion 620 includes a step portion 620a on the inside and the outside. Specifically, the first protrusion portion 620 is provided such that the thickness increases in the -Z direction.

As described above, the first opening portion 110, into which the first bevel gear 300 constituting the power transmission mechanism is inserted, is provided on the inside of the first protrusion portion 620. The inner ring 640A of the second bearing 640 is supported on the outside of the first protrusion portion 620. The outer ring 350A1 of the first bearing 350A is supported on the inside of the first protrusion portion 620.

As described above, since the outer ring 640B of the second bearing 640 is fixed to the second protrusion portion 610 by the outer ring pinching portion 612, in other words, the second bearing 640 is fixed to the fourth arm 224, the fifth arm 225 can be lightened as compared with a case where the second protrusion portion 610 is disposed in the fifth arm 225. Therefore, the operational performance of the fifth arm 225 can be improved.

As described above, the first bevel gear 300 is inserted into the first opening portion 110 of the first protrusion portion 620. The outer ring 350A1 of the first bearing 350A that rotatably supports the first bevel gear 300 is disposed in a part 111 of the first opening portion 110.

The pressing portion 700 that supports the outer ring 350A1 of the first bearing 350A is disposed at the distal end of the first protrusion portion 620, that is, at the end portion on the +Z direction side. As described above, the pressing portion 700 includes the holding portion 710 fixed to the first protrusion portion 620, the spacer 730 disposed on the first bearing 350A side, and the elastic member 720 disposed between the holding portion 710 and the spacer 730. The holding portion 710 is pressed in the direction of the rotation axis J5, specifically, in the -Z direction by the fixing bolt 621, and is fixed to the first protrusion portion 620.

As described above, since the first bearing 350A is fixed by the holding portion 710, the elastic member 720, the spacer 730, that is, the pressing portion 700, and the fixing bolt 621, the occurrence of fretting due to a thermal expansion difference, that is, minute wear, abnormal noise, and vibration can be suppressed.

In addition, the first bearing 350A is disposed in the part 111 of the first opening portion 110 of the first protrusion portion 620, and the second bearing 640 is disposed on the outside of the first protrusion portion 620, that is, the two bearings 350A and 640 can be supported by the first protrusion portion 620, and thus the size of the first protrusion portion 620 can be made compact, and the size of the fifth arm 225 can be reduced. Specifically, the shortening of the arm length of the fifth arm 225 and the reduction of the inertia of the fifth arm 225, that is, the reduction of the inertial moment, can contribute to the improvement of the operational performance.

In addition, the first protrusion portion 620 is provided in a shape in which the thickness decreases toward the distal end side, that is, the +Z direction side. The second bearing 640 is disposed closer to the distal end side than the first bearing 350A. As described above, since the second bearing 640 is disposed on the distal end side of the first protrusion portion 620 having a reduced thickness, the size of the first protrusion portion 620 including the second bearing 640 can be made compact, and the size of the fifth arm 225 can be reduced.

The operation portion 311 including a step or a recessed portion is provided at the one end 310a of the first shaft portion 310 of the first bevel gear 300. By providing the step or the recessed portion, in a case where the backlash between the first bevel gear 300 and the second bevel gear 400 is adjusted, the operation portion 311 can be rotated to check the backlash amount.

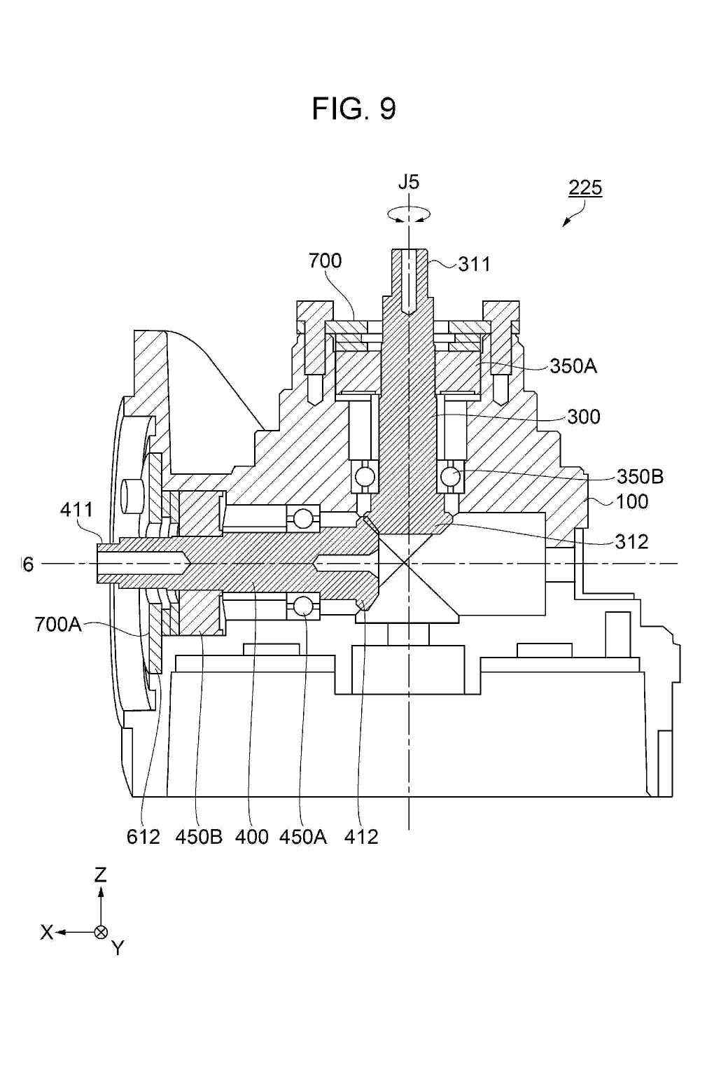

The operation portion 311 is disposed to protrude outward beyond the first protrusion portion 620 and the pressing portion 700, that is, in the +Z direction (refer to FIG. 9). As described above, since the operation portion 311 protrudes from the first protrusion portion 620 and the pressing portion 700 around the operation portion 311, there is no member that interferes with the operation portion 311, and the gear contact adjustment can be easily performed.

As described above, the pressing portion 700 for fixing the first bearing 350A includes the elastic member 720, which can prevent a gap from being easily formed between the pressing portion 700 and the first bearing 350A due to the elastic member 720, and can prevent excessive pressure from being easily applied to the first bearing 350A in a case where the elastic member 720 is crushed. Therefore, the backlash between the first bevel gear 300 and the second bevel gear 400 can be maintained within an appropriate range. As a result, the gear contact accuracy can be improved.

Further, since the elastic member 720 is sandwiched between the holding portion 710 and the spacer 730, the protrusion of the elastic member 720 in the direction of the first bearing 350A can be suppressed in a case where the elastic member 720 is crushed. Therefore, the influence on the operation of the arm can be suppressed.

Further, since the outer ring 640B of the second bearing 640 is fixed to the second protrusion portion 610 by the outer ring pinching portion 612, in other words, the second bearing 640 and the outer ring pinching portion 612 can be fixed to the fifth arm 225, for example, the fifth arm 225 can be lightened as compared with a case where the second bearing 640 and the outer ring pinching portion 612 are disposed in the sixth arm 226. Therefore, the operational performance of the fifth arm 225 can be improved.

Further, since the second shaft portion 410 of the second bevel gear 400 is supported by the housing 100 via the third bearing 450, the second bevel gear 400 can be fixed to the housing 100 in both a state where the speed reducer 510 is coupled to the second bevel gear 400 and a state where the speed reducer 510 is removed from the second bevel gear 400. Therefore, the backlash adjustment between the first bevel gear 300 and the second bevel gear 400, in other words, the gear contact adjustment can be performed, and thus, an increase in the gap between the first bevel gear 300 and the second bevel gear 400 can be suppressed. As a result, the operational performance of the fifth arm 225 and the sixth arm 226 can be improved.

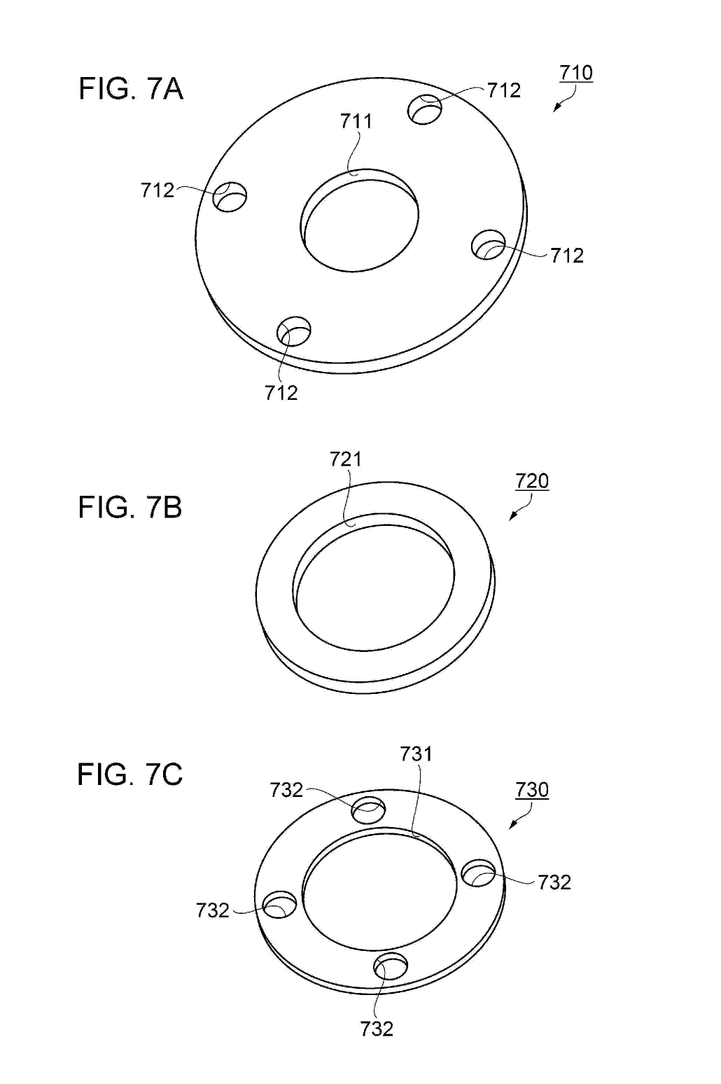

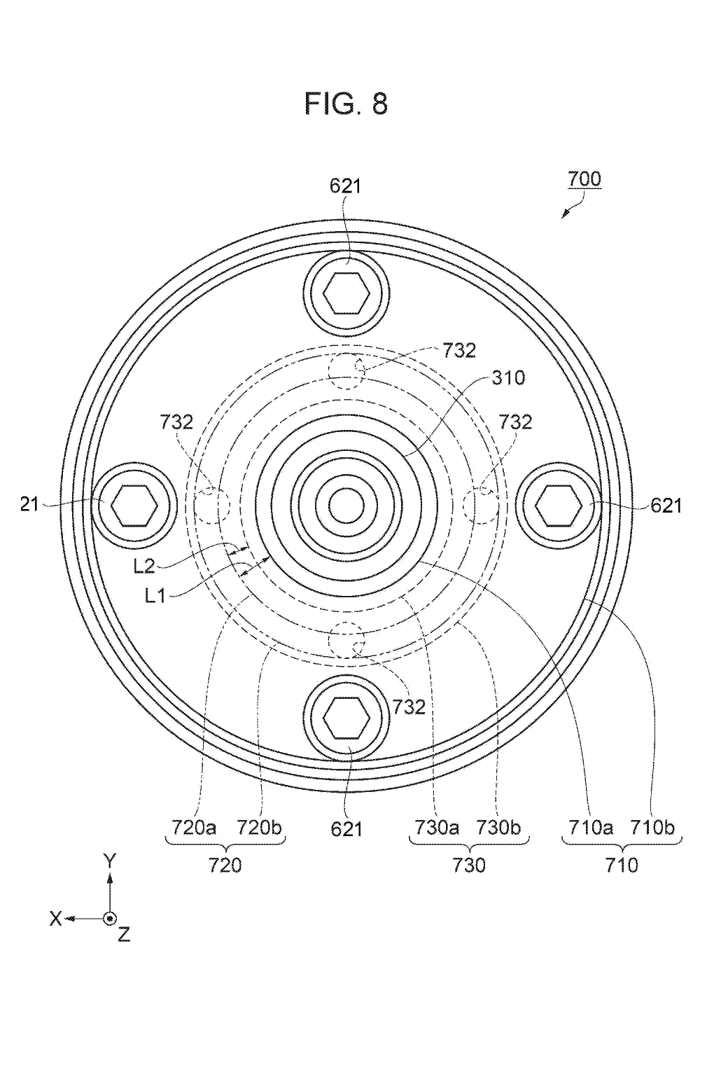

Next, a configuration of the pressing portion 700 will be described with reference to FIGS. 7A, 7B, 7C, and 8. FIG. 8 is a plan view of the pressing portion 700 viewed from the +Z direction, that is, a plan view illustrating the positional relationship between the holding portion 710, the elastic member 720, and the spacer 730 in a case where the holding portion 710, the elastic member 720, and the spacer 730 are disposed to be superimposed on each other.

As illustrated in FIGS. 7A to 8, the pressing portion 700 includes the holding portion 710 fixed to the first protrusion portion 620, the spacer 730 disposed on the first bearing 350A side, and the elastic member 720 disposed between the holding portion 710 and the spacer 730, as described above.

As illustrated in FIG. 7A, the holding portion 710 is formed in a circular shape having a through-hole 711 as a first through-hole. The first shaft portion 310 of the first bevel gear 300 is inserted into the through-hole 711. A through-hole 712 into which the fixing bolt 621 used in a case of fixing to the first protrusion portion 620 is inserted is provided around the through-hole 711. In the present embodiment, the through-holes 712 are provided at, for example, four locations at equal intervals.

As illustrated in FIG. 7B, the elastic member 720 is formed in a circular shape having a through-hole 721 as a first through-hole. The first shaft portion 310 of the first bevel gear 300 is inserted into the through-hole 721.

As illustrated in FIG. 7C, the spacer 730 is formed in a circular shape having a through-hole 731 as a first through-hole. The first shaft portion 310 of the first bevel gear 300 is inserted into the through-hole 731. A through-hole 732 as a second through- hole, which is for absorbing a part of the elastic member 720 that moves in a case where the elastic member 720 is crushed, is provided around the through-hole 731. In the present embodiment, the through-holes 732 are provided at, for example, four locations at equal intervals. Since the through-holes 732 are provided, even in a case where the elastic member 720 is crushed, the contact of a part of the elastic member 720 with the first shaft portion 310 of the first bevel gear 300 disposed on the inside can be suppressed.

As illustrated in FIG. 8, the pressing portion 700 includes the holding portion 710 disposed on the top surface, the elastic member 720 disposed below the holding portion 710, and the spacer 730 disposed below the elastic member 720.

An end portion 710a of the holding portion 710 on the inner diameter side protrudes inward beyond an end portion 720a of the elastic member 720 on the inner diameter side by a length L1, that is, to the first shaft portion 310 side. An end portion 730a of the spacer 730 on the inner diameter side protrudes inward beyond the end portion 720a of the elastic member 720 on the inner diameter side by a length L2, that is, to the first shaft portion 310 side. In other words, the end portion 720a of the elastic member 720 on the inner diameter side is disposed at a position farther from the first shaft portion 310 than the end portion 710a of the holding portion 710 and the end portion 730a of the spacer 730.

As described above, the end portion 710a of the holding portion 710 protrudes inward beyond the end portion 720a of the elastic member 720, and the end portion 730a of the spacer 730 protrudes inward beyond the end portion 720a of the elastic member 720. Therefore, even in a case where the pressing portion 700 is pressed and the elastic member 720 is crushed by the pressure applied to the elastic member 720, the contact with the first shaft portion 310 of the first bevel gear 300 disposed on the inside can be suppressed, and the influence on the operation of the fifth arm 225 can be suppressed.

Further, since the holding portion 710, that is, the pressing portion 700 is fixed by the fixing bolt 621 as a fixing screw, the first bearing 350A can be fixed with a predetermined force, and the rattling of the first bearing 350A can be suppressed. In FIG. 8, the outer diameter of the holding portion 710 is illustrated as the end portion 710b, the outer diameter of the elastic member 720 is illustrated as the end portion 720b, and the outer diameter of the spacer 730 is illustrated as the end portion 730b.

As described above, the vertical articulated robot 1 includes the fourth arm 224 including the motors 41 and 61, the fifth arm 225 that is provided at the fourth arm 224 and is rotated around the rotation axis J5, and the sixth arm 226 that is provided at the fifth arm 225 and is rotated around the rotation axis J6 intersecting with the rotation axis J5. The fifth arm 225 includes the housing 100 including the first protrusion portion 620 that protrudes along the rotation axis J5 and the first opening portion 110 that is provided on the inside of the first protrusion portion 620, the first bevel gear 300 including the first shaft portion 310 that extends along the rotation axis J5, the operation portion 311 that is provided at the one end 310a of the first shaft portion 310 and includes a step or a recessed portion, and the first bevel gear portion 312 that is provided at another end 310b of the first shaft portion 310, the first bevel gear 300 being inserted into the first opening portion 110, the first bearing 350A that is disposed in the first opening portion 110, includes the outer ring 350A1 and the inner ring 350A2, and rotatably supports the first shaft portion 310, and the pressing portion 700 including the holding portion 710 that is fixed to the first protrusion portion 620, and the elastic member 720 that is disposed between the holding portion 710 and the first bearing 350A, the pressing portion 700 pressing the outer ring 350A1 from the outside along the rotation axis J5. The operation portion 311 protrudes outward beyond the first protrusion portion 620 and the pressing portion 700.

According to this configuration, the pressing portion 700 for fixing the first bearing 350A includes the elastic member 720, which can prevent a gap from being easily formed between the pressing portion 700 and the first bearing 350A, and can prevent excessive pressure from being easily applied to the first bearing 350A in a case where the elastic member 720 is crushed, due to the elastic member 720. Therefore, the backlash of the first bevel gear 300 can be maintained within an appropriate range. As a result, the gear contact accuracy can be improved. In addition, since the operation portion 311 protrudes beyond the first protrusion portion 620 and the pressing portion 700 around the operation portion 311, the gear contact adjustment can be easily performed.

In addition, by maintaining the backlash within an appropriate range, the sliding unevenness of the first bearing 350A can be suppressed. As a result, the torque at the time of driving the first bevel gear 300 can be stabilized.

In addition, in the vertical articulated robot 1 of the present embodiment, it is preferable that the end portion 710a of the holding portion 710 on the inner diameter side protrudes inward beyond the end portion 720a of the elastic member 720 on the inner diameter side. According to this configuration, the end portion 710a of the holding portion 710 protrudes inward beyond the end portion 720a of the elastic member 720, in other words, the end portion 720a of the elastic member 720 does not protrude toward the inner diameter side. Therefore, even in a case where the pressing portion 700 is pressed and the elastic member 720 is crushed by the pressure applied to the elastic member 720, the contact with the first bevel gear 300 disposed on the inside can be suppressed, and the influence on the operation of the fifth arm 225 can be suppressed.

In addition, in the vertical articulated robot 1 of the present embodiment, it is preferable that the spacer 730 is disposed between the elastic member 720 and the first bearing 350A. According to this configuration, since the elastic member 720 is sandwiched between the holding portion 710 and the spacer 730, the protrusion of the elastic member 720 in the direction of the first bearing 350A can be suppressed in a case where the elastic member 720 is crushed. Therefore, the influence on the operation of the fifth arm 225 can be suppressed.

In addition, in the vertical articulated robot 1 of the present embodiment, it is preferable that the end portion 730a of the spacer 730 on the inner diameter side protrudes toward the inner diameter side beyond the end portion 720a of the elastic member 720 on the inner diameter side. According to this configuration, the end portion 730a of the spacer 730 protrudes inward beyond the end portion 720a of the elastic member 720, in other words, the end portion 720a of the elastic member 720 does not protrude toward the inner diameter side. Therefore, even in a case where the pressing portion 700 is pressed and the elastic member 720 is crushed by the pressure applied to the elastic member 720, the contact with the first bevel gear 300 disposed on the inside can be suppressed, and the influence on the operation of the fifth arm 225 can be suppressed.

In addition, in the vertical articulated robot 1 of the present embodiment, the pressing portion 700 preferably includes the fixing bolt 621, and the through-hole 712 through which the fixing bolt 621 passes is preferably provided on the outside of the holding portion 710. According to this configuration, since the holding portion 710 is fixed by the fixing bolt 621, the first bearing 350A can be fixed with a predetermined force, and the rattling of the first bearing 350A in the axis direction of the rotation axis J5 can be suppressed.

In addition, in the vertical articulated robot 1 of the present embodiment, the fourth arm 224 preferably includes the tubular second protrusion portion 610 protruding along the rotation axis J5 and including the shoulder portion 611 on the inside, and the outer ring pinching portion 612 that pinches the outer ring 640B of the second bearing 640 together with the shoulder portion 611 and is fixed to the second protrusion portion 610. According to this configuration, since the outer ring 640B of the second bearing 640 is fixed to the second protrusion portion 610 by the outer ring pinching portion 612, in other words, the second bearing 640 and the outer ring pinching portion 612 can be fixed to the fifth arm 225, for example, the fifth arm 225 can be lightened as compared with a case where the second bearing 640 and the outer ring pinching portion 612 are disposed in the sixth arm 226. Therefore, the operational performance of the fifth arm 225 can be improved.

In addition, in the vertical articulated robot 1 of the present embodiment, the fifth arm 225 preferably includes the second shaft portion 410 that extends along the rotation axis J6, the second bevel gear portion 412 that is provided at the one end 410a of the second shaft portion 410 and receives a force by meshing with the first bevel gear portion 312, and the coupling portion 411 that is provided at another end 410b of the second shaft portion 410, the second bevel gear 400 that is inserted in the second opening portion 120, and at least one third bearing 450 that rotatably supports the second shaft portion 410 with respect to the housing 100. The sixth arm 226 preferably includes the flange 500, the speed reducer 510 that is coupled to the flange 500 and amplifies the received force to drive the flange 500, and the fitting member 520 that is inserted into the speed reducer 510 and is detachably fitted to the coupling portion 411 of the second shaft portion 410.

According to this configuration, since the second shaft portion 410 of the second bevel gear 400 is supported by the housing 100 via the third bearing 450, the second bevel gear 400 can be fixed to the housing 100 in both a state where the speed reducer 510 is coupled to the second bevel gear 400 and a state where the speed reducer 510 is removed from the second bevel gear 400. Therefore, the backlash adjustment between the first bevel gear 300 and the second bevel gear 400, in other words, the gear contact adjustment can be performed, and thus, an increase in the gap between the first bevel gear 300 and the second bevel gear 400 can be suppressed. As a result, the operational performance of the fifth arm 225 and the sixth arm 226 can be improved.

Hereinafter, a modification example of the embodiment described above will be described.

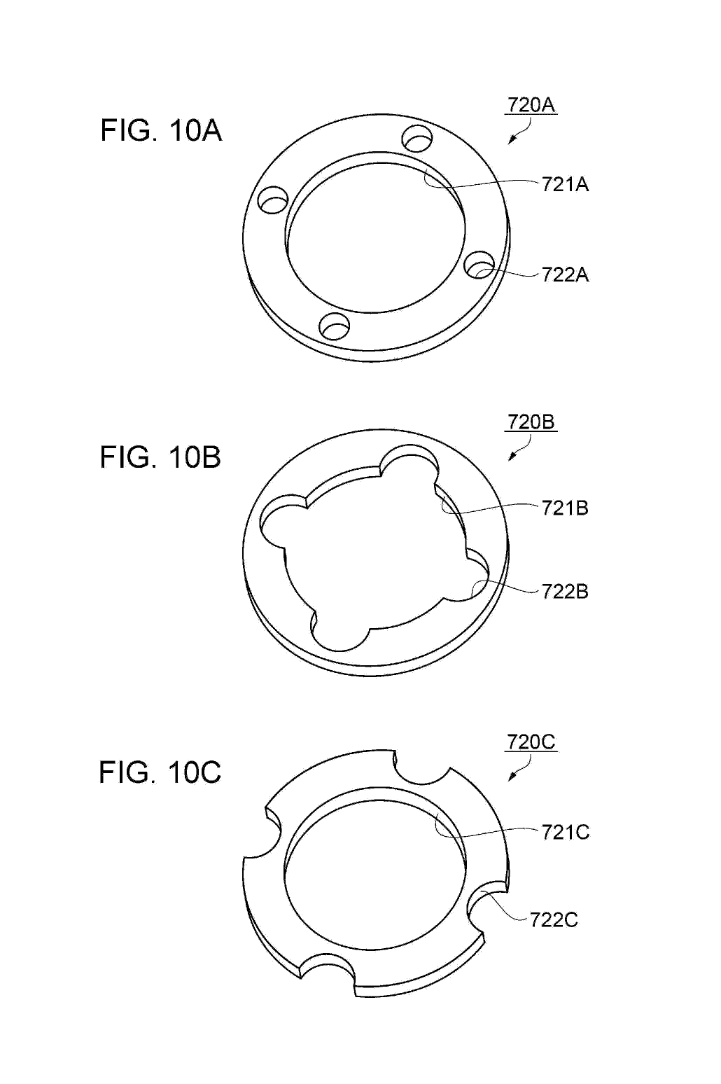

As described above, the elastic member 720 is not limited to the above-described configuration, and may have the configuration illustrated in FIGS. 10A, 10B, and 10C.

As illustrated in FIG. 10A, in an elastic member 720A of the modification example, through-holes 722A are provided at four locations at equal intervals around a through-hole 721A. Since the through-holes 722A are provided, in a case where the elastic member 720 is crushed, a part of the elastic member 720 that moves can be absorbed by the through-holes 722A of the elastic member 720.

As illustrated in FIG. 10B, an elastic member 720B of the modification example is provided with notches that are connected to a through-hole 721B at four locations at equal intervals around the through-hole 721B, in other words, recessed portions 722B that are recessed in the radial direction. Since the recessed portions 722B are provided, in a case where the elastic member 720 is crushed, a part of the elastic member 720 that moves can be absorbed by the recessed portions 722B.

As illustrated in FIG. 10C, an elastic member 720C of the modification example is provided with notches that are connected to the outer periphery at four locations at equal intervals around a through-hole 721C, in other words, recessed portions 722C that are recessed in the radial direction. Since the recessed portions 722C are provided, in a case where the elastic member 720 is crushed, a part of the elastic member 720 that moves can be absorbed by the recessed portions 722C.

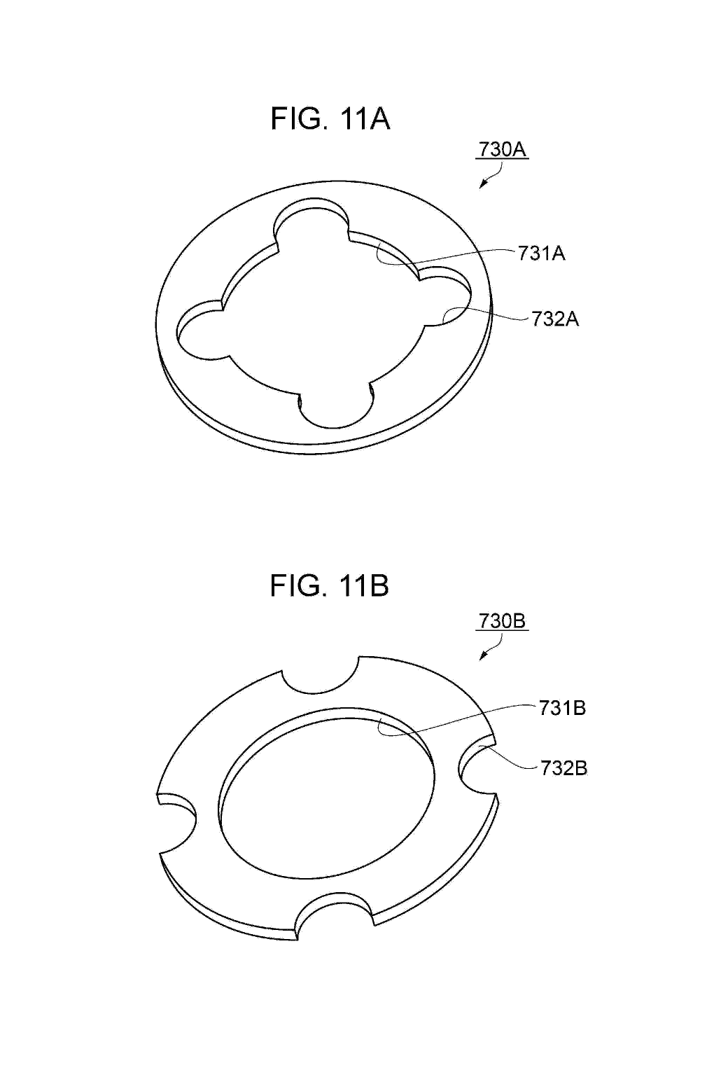

As described above, the spacer 730 is not limited to the above-described configuration, and may have the configuration illustrated in FIGS. 11A and 11B.

As illustrated in FIG. 11A, a spacer 730A of the modification example is provided with notches that are connected to a through-hole 731A at four locations at equal intervals around the through-hole 731A, in other words, recessed portions 732A that are recessed in the radial direction. Since the recessed portions 732A are provided, in a case where the elastic member 720 is crushed, a part of the elastic member 720 that moves can be absorbed by the recessed portions 732A.

As illustrated in FIG. 11B, a spacer 730B of the modification example is provided with notches that are connected to the outer diameter at four locations at equal intervals around a through-hole 731B, in other words, recessed portions 732B that are recessed in the radial direction. Since the recessed portions 732B are provided, in a case where the elastic member 720 is crushed, a part of the elastic member 720 that moves can be absorbed by the recessed portions 732B.

In the holding portion 710, as in the modification example described above, through-holes or recessed portions may be provided around the through-hole 711.

As described above, in the vertical articulated robot 1 of the modification example, the through-holes 721A, 721B, 721C, 731A, and 731B through which the first bevel gear 300 passes are provided at the center of the holding portion 710, the elastic member 720, and the spacer 730, and at least one of the holding portion 710, the elastic member 720, and the spacer 730 is preferably provided with the through-holes 722A or the recessed portions 722B, 722C, 732A, and 732B recessed in the radial direction around the through-holes 721A, 721B, 721C, 731A, and 731B. According to this configuration, the through-holes 722A and the recessed portions 722B, 722C, 732A, and 732B are provided around the through-holes 721A, 721B, 721C, 731A, and 731B through which the first bevel gear 300 passes. Therefore, even in a case where the pressing portion 700 is pressed and the elastic member 720 is crushed, the crushed portion that moves can be released to the through-holes 722A and the recessed portions 722B, 722C, 732A, and 732B, and the contact with the first bevel gear 300 disposed on the inside can be suppressed.

As in the above-described embodiment and modification example, the present disclosure is not limited to the holding portion 710, the elastic member 720, and the spacer 730, which are provided with the through-holes 732 and 722A for absorbing a part of the elastic member 720, and the recessed portions 722B, 722C, 732A, and 732B. For example, at least one of the holding portion 710, the elastic member 720, and the spacer 730 may be provided with a portion with a reduced thickness that absorbs a part of the elastic member 720 around the through-holes 711, 721, and 731. In addition, a portion with a reduced thickness may be provided in the holding portion 710, the elastic members 720A, 720B, and 720C, and the spacers 730A and 730B of the modification example.

As described above, in the vertical articulated robot 1 of the modification example, the through-holes 721A, 721B, 721C, 731A, and 731B through which the first bevel gear 300 passes are provided at the center of the holding portion 710, the elastic member 720, and the spacer 730, and at least one of the holding portion 710, the elastic member 720, and the spacer 730 is preferably provided with a portion with a reduced thickness around the through-holes 721A, 721B, 721C, 731A, and 731B.

According to this configuration, a portion with a reduced thickness is provided around the through-holes 721A, 721B, 721C, 731A, and 731B through which the first bevel gear 300 passes. Therefore, even in a case where the pressing portion 700 is pressed and the elastic member 720 is crushed, the crushed portion can be released to the thin portion, and the contact with the first bevel gear 300 disposed on the inside can be suppressed.

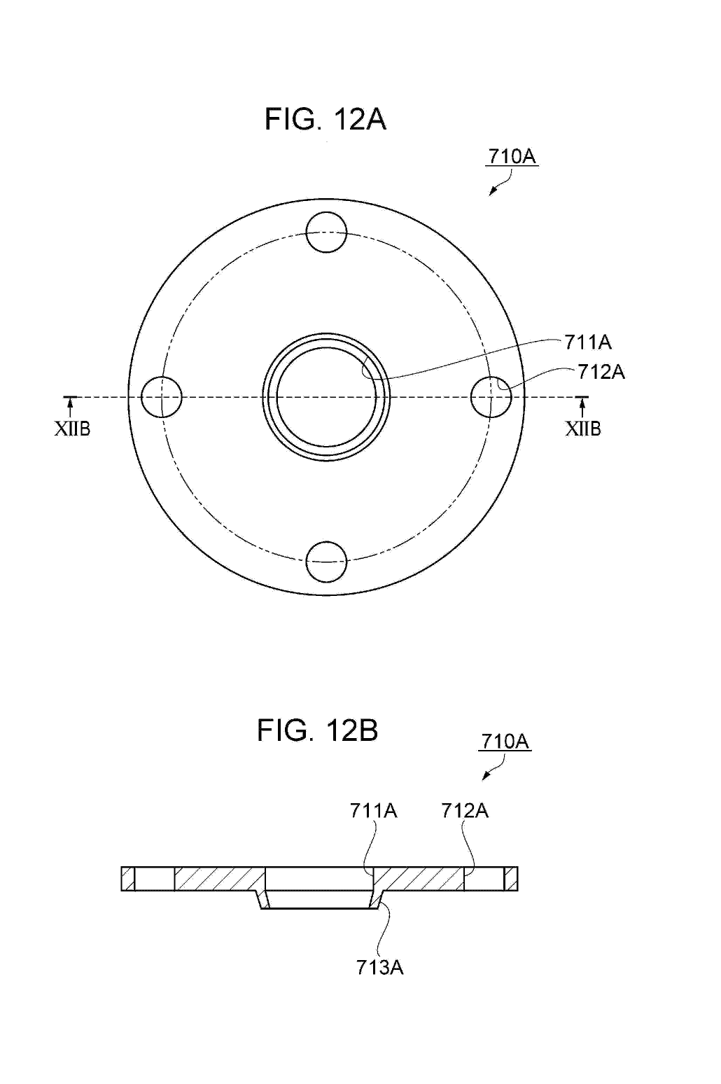

As described above, the holding portion 710 is not limited to being formed in an annular shape having a uniform thickness, and may be configured as illustrated in FIGS. 12A and 12B. As illustrated in FIGS. 12A and 12B, a holding portion 710A of the modification example is provided with a flange 713A that is inclined toward the elastic member 720 side at an end portion 711A on the inner diameter side.

As described above, the flange 713A is provided at the holding portion 710A disposed on the elastic member 720. Therefore, even in a case where the elastic member 720 is crushed, a part of the crushed elastic member 720 that moves, in other words, a part of the protruded elastic member 720 can be stopped with the flange 713A, and the contact with the first bevel gear 300 disposed on the inside can be suppressed.

As described above, the spacer 730 is not limited to being formed in an annular shape having a uniform thickness, and the flange 713A that is inclined toward the elastic member 720 side may be provided as in the holding portion 710A of the modification example described above.

As described above, in the vertical articulated robot 1 of the modification example, the flange 713A that is inclined toward the elastic member 720 side is preferably provided at the end portion 711A of the holding portion 710 on the inner diameter side. According to this configuration, the flange 713A is provided at the holding portion 710A disposed on the elastic member 720. Therefore, even in a case where the elastic member 720 is crushed, a part of the crushed elastic member 720 that moves, in other words, a part of the protruded elastic member 720 can be stopped with the flange 713A, and the contact with the first bevel gear 300 disposed on the inside can be suppressed.

As described above, in the vertical articulated robot 1 of the modification example, the flange 713A that is inclined toward the elastic member 720 side is preferably provided at the end portion 711A of the spacer 730 on the inner diameter side. According to this configuration, the flange 713A is provided at the spacer 730 disposed below the elastic member 720. Therefore, even in a case where the elastic member 720 is crushed, a part of the crushed elastic member 720 that moves, in other words, a part of the protruded elastic member 720 can be stopped with the flange 713A, and the contact with the first bevel gear 300 disposed on the inside can be suppressed.

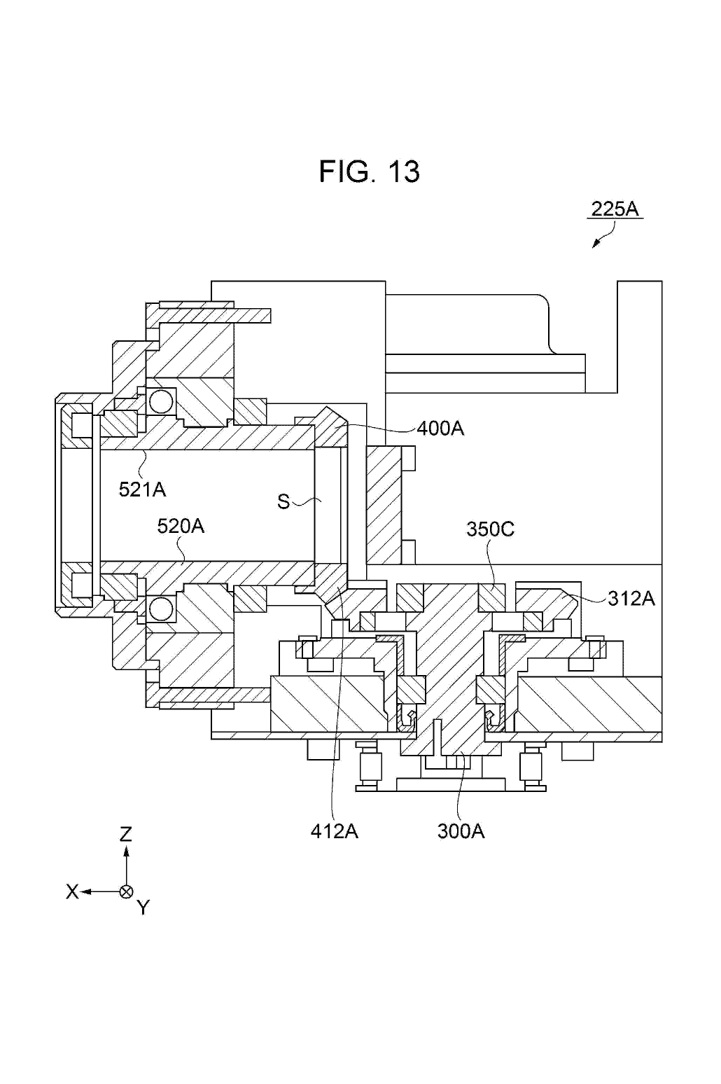

As described above, the configuration of the first bevel gear 300, the second bevel gear 400, and the fitting member 520 may be the configuration as illustrated in FIG. 13.

Specifically, in a fifth arm 225A of the modification example, a first bevel gear portion 312A is provided at the distal end of a first bevel gear 300A, that is, a part in the +Z direction, and a fourth bearing 350C is disposed at a part of the distal end. In addition, a second bevel gear 400A has a hollow structure S inside. A second shaft portion 520A is provided with a through-hole 521A as in the embodiment. That is, the inside from the second shaft portion 520A to the second bevel gear 400A has the hollow structure S.

As described above, in the vertical articulated robot 1 of the modification example, the fifth arm 225A preferably includes the second bevel gear 400A including the second shaft portion 520A that extends along the rotation axis J6 and a second bevel gear portion 412A that is provided at one end of the second shaft portion 520A and receives a force by meshing with the first bevel gear portion 312A, the fourth bearing 350C is preferably disposed at the distal end of the first bevel gear portion 312A in the first bevel gear 300A, and the second bevel gear 400A preferably has a hollow structure. According to this configuration, the fifth arm 225A can be lightened, and the operational performance of the fifth arm 225A and the sixth arm 226 can be improved.

As described above, in addition to the pressing portion 700 being disposed on the one end 310a side of the first shaft portion 310 of the first bevel gear 300, a pressing portion 700A may be disposed on another end 410b side of the second shaft portion 410 of the second bevel gear 400. That is, the pressing portion 700A is disposed on the output side of the second bevel gear 400, not limited only to the input side of the first bevel gear 300 (refer to FIGS. 3 and 9).

As described above, the outer ring pinching portion 612 that fixes the outer ring 640B of the second bearing 640 is not limited to being disposed separately from the second protrusion portion 610, and may be provided integrally with the second protrusion portion 610.

1. A vertical articulated robot comprising:
a root arm member that includes a motor;
a first arm member that is provided at the root arm member and is rotated around a first axis; and
a second arm member that is provided at the first arm member and is rotated around a second axis intersecting with the first axis, wherein
the first arm member includes
a housing that includes a first protrusion portion protruding along the first axis and a first opening portion provided on an inside of the first protrusion portion,
a first bevel gear that includes a first shaft portion extending along the first axis, an operation portion provided at one end of the first shaft portion and having a step or a recessed portion, and a first bevel gear portion provided at another end of the first shaft portion, the first bevel gear being inserted into the first opening portion,
a first bearing that is disposed in the first opening portion, includes an outer ring and an inner ring, and rotatably supports the first shaft portion, and
a pressing portion that includes a holding portion fixed to the first protrusion portion and an elastic member disposed between the holding portion and the first bearing, the pressing portion pressing the outer ring from an outside along the first axis, and
the operation portion protrudes outward beyond the first protrusion portion and the pressing portion.

2. The vertical articulated robot according to claim 1, wherein
an end portion of the holding portion on an inner diameter side protrudes inward beyond an end portion of the elastic member on the inner diameter side.

3. The vertical articulated robot according to claim 1, wherein
a flange inclined toward an elastic member side is provided at an end portion of the holding portion on an inner diameter side.

4. The vertical articulated robot according to claim 1, wherein
a spacer is disposed between the elastic member and the first bearing.

5. The vertical articulated robot according to claim 4, wherein
an end portion of the spacer on an inner diameter side protrudes toward the inner diameter side beyond an end portion of the elastic member on an inner diameter side.

6. The vertical articulated robot according to claim 4, wherein
a flange inclined toward an elastic member side is provided at an end portion of the spacer on an inner diameter side.

7. The vertical articulated robot according to claim 1, wherein
the pressing portion includes a fixing screw, and
a hole through which the fixing screw passes is provided on an outside of the holding portion.

8. The vertical articulated robot according to claim 4, wherein
a first through-hole through which the first bevel gear passes is provided at a center of the holding portion, the elastic member, and the spacer, and
at least one of the holding portion, the elastic member, and the spacer is provided with a second through-hole or a recessed portion recessed in a radial direction around the first through-hole.

9. The vertical articulated robot according to claim 8, wherein
the first through-hole through which the first bevel gear passes is provided at the center of the holding portion, the elastic member, and the spacer, and
at least one of the holding portion, the elastic member, and the spacer is provided with a portion having a reduced thickness around the first through-hole.

10. The vertical articulated robot according to claim 1, wherein
the root arm member includes
a tubular second protrusion portion that protrudes along the first axis and includes a shoulder portion on an inside, and
an outer ring pinching portion that pinches an outer ring of a second bearing together with the shoulder portion and is fixed to the second protrusion portion.

11. The vertical articulated robot according to claim 1, wherein
the housing includes
a second opening portion provided at a position different from the first opening portion, and
the first arm member includes
a second bevel gear that includes a second shaft portion extending along the second axis, a second bevel gear portion that is provided at one end of the second shaft portion and receives a force by meshing with the first bevel gear portion, and a coupling portion that is provided at another end of the second shaft portion, the second bevel gear being inserted into the second opening portion, and
at least one third bearing that rotatably supports the second shaft portion with respect to the housing, and
the second arm member includes
a flange,
a speed reducer that is coupled to the flange and amplifies the received force to drive the flange, and
a fitting member that is inserted into the speed reducer and is detachably fitted to the coupling portion of the second shaft portion.

12. The vertical articulated robot according to claim 1, wherein
the first arm member includes
a second bevel gear that includes a second shaft portion extending along the second axis and a second bevel gear portion that is provided at one end of the second shaft portion and receives a force by meshing with the first bevel gear portion,
in the first bevel gear, a fourth bearing is disposed at a distal end of the first bevel gear portion, and
the second bevel gear has a hollow structure.

13. A vertical articulated robot comprising:
a root arm member that includes a motor;
a first arm member that is provided at the root arm member and is rotated around a first axis; and
a second arm member that is provided at the first arm member and is rotated around a second axis intersecting with the first axis, wherein
the first arm member includes
a housing that includes a first protrusion portion protruding along the first axis, a first opening portion provided on an inside of the first protrusion portion, and a second opening portion provided at a position different from the first opening portion,
a first bevel gear that includes a first shaft portion extending along the first axis, an operation portion provided at one end of the first shaft portion and having a step or a recessed portion, and a first bevel gear portion provided at another end of the first shaft portion, the first bevel gear being inserted into the first opening portion,
a second bevel gear that includes a second shaft portion extending along the second axis and a second bevel gear portion that is provided at one end of the second shaft portion and receives a force by meshing with the first bevel gear portion, the second bevel gear being inserted into a second opening portion,
a first bearing that is disposed in the first opening portion and rotatably supports the first shaft portion,
a second bearing that is disposed at an outside of the first protrusion portion and rotatably supports the first arm member with respect to the root arm member,
a third bearing that rotatably supports the second shaft portion, and
a pressing portion pressing the first bearing from an outside along the first axis, and
the operation portion protrudes outward beyond the first protrusion portion and the pressing portion.
